(19) United States
(12) Patent Application Publication
(10) Pub. No.: US 2009/0223780 A1
(43) Pub. Date: Sep. 10, 2009

(54) WORKPIECE CARRIER DEVICE AND A CONVEYOR DEVICE FOR WORKPIECE CARRIER DEVICES

(75) Inventors: Matthias KRUPS, Konigswinter (DE); Peter KRUPS, Anhausen (DE)

Correspondence Address: Clements Bernard PLLC, 1901 Roxborough Road, Suite 300, Charlotte, NC, 28211, US

(73) Assignee: CERATIS GMBH, Dernbach (DE)

(21) Appl. No.: 12/397,549

(22) Filed: Mar. 4, 2009

(30) Foreign Application Priority Data
Mar. 5, 2008 (DE) 10 2008 012 707.8

(51) Int. Cl. B65G 17/32

(52) U.S. Cl. 198/474.1

(57) ABSTRACT

A workpiece carrier device for loose placement on friction or chain conveyors, comprising at least one motion element with a friction surface in contact with the friction conveyor or with a form-fit element cooperating with the chain conveyor for transmitting movement through friction forces or form-fit engagement, respectively, a carrier element for receiving a workpiece, said carrier element being connected with the motion element, and at least one supporting element for absorbing at least a part of the workpiece weight, said supporting element being connected with the carrier element and being independent of the motion element, wherein at least two motion elements are provided that are perpendicular to each other.

### BACKGROUND OF THE INVENTION

### Field of the Invention

The invention is directed to a workpiece carrier device loosely placed on a friction conveyor or a chain conveyor. The invention is further directed to a conveyor device for such workpiece carrier devices, the conveyor device being a friction or chain conveyor.

Particularly in mass production, conveyor means are used to transport workpieces between individual workplaces where the workpieces are assembled or processed, for example. To do so, the workpieces are placed on workpiece carrier devices and the workpiece carrier devices are moved together with the workpieces by corresponding conveyor means. Friction conveyors or chain conveyors are particularly known for displacing the workpiece carrier devices.

Chain conveyors comprise an endless chain, form-fit elements, such as toothed racks, connected with the workpiece carriers engaging the chain links for transport.

With friction conveyors, the workpiece carrier devices are not rigidly connected with the conveyor means, but may rest loosely on rollers, for example. The displacement of the workpiece carrier devices is effected through friction forces occurring between the rollers, belts or plates and friction surfaces of the workpiece carrier device. It is a particular advantage of friction conveyors that they allow for a back-up of the workpiece carrier devices. Here, during the back-up process, the corresponding drive means of the friction conveyors slip. Friction conveyors require no intricate and complicated unlatching from a conveyor means, such as a chain. Another advantage of friction conveyors is that curves and especially branches can be realized in a simple manner. Using branching means, such as points, individual workpiece carrier devices may be discharged or introduced, for example. Thus, friction conveyors have a great flexibility. Such a friction conveyor is described in DE 40 36 214.

If the workpieces are heavy workpieces, particularly weighing over 100 kg, and/or workpieces of large dimensions, friction conveyors have the drawback that unfavourable friction conditions occur especially in the area of curves and branches. The friction conditions occurring when workpiece carriers back up are disadvantageous as well. Another drawback of friction conveyors for large workpieces is that the conveyor paths have to be made very wide. This increases the costs of such friction conveyors.

For both friction and chain conveyers it is basically known to provide branches. Here, the workpiece carrier is moved sideways at a branch so that, with respect to the transport direction, a lateral edge of the workpiece carrier becomes a front edge. Behind the branch, the original front edge of the workpiece carrier becomes a lateral edge. To be able to realize such branches, it is known for both friction and chain conveyors to lift the workpiece carrier together with the workpiece, displace it laterally and put it back onto the branched transport path. In particular with heavy workpieces, such devices for shifting the workpieces have to be of a very solid design. Heavy weights have to be lifted so that often complex hydraulic lifting devices are required.

Another problem with workpiece carriers, especially with workpiece carriers serving to rest on friction conveyors, is that the workpieces lying on the workpiece carrier are not accessible from below. Assembly or processing steps to be performed on the underside resting on the workpiece carrier or from below, thus require the workpiece to be lifted from the workpiece carrier. Again, solid and complex lifting devices are required, especially for heavy workpieces.

### SUMMARY OF THE INVENTION

It is an object of the invention to provide workpiece carrier devices to be placed loosely on friction or chain conveyors, with which branches are easier to realize. In this respect, it is a particular object of the invention to avoid a lifting of the workpiece carrier together with the workpiece.

It is another object of the invention to provide a conveyor device suited for that purpose.

The workpiece carrier device of the present invention is intended for loose placement on a friction conveyor, such as a roller conveyor, a belt conveyor or a plate conveyor. The workpiece carrier device is thus displaced by means of friction forces exerted by the friction conveyor on the workpiece carrier device. To achieve this, the workpiece carrier device comprises a motion element resting on the friction conveyer by a friction surface. A carrier element is connected, preferably rigidly, with the especially plate-shaped motion element. The carrier element is preferably also plate-shaped and serves to receive one or possibly a plurality of workpieces. According to the present invention, the carrier element is connected with support elements. At least part of the weight of the workpieces is absorbed via the support elements. According to the invention, the weight of the workpiece thus acts on the motion element only in part, if at all. As provided by the invention, a part, preferably a substantial part, of the weight of the workpiece is absorbed or supported by the support elements. Preferably, more than 50%, especially more than 70% and, most preferred, more than 90% of the weight of the workpiece is absorbed by the at least one support element. The at least one support element connected with the carrier element transmits the weight force to an absorption element which may be a part of the friction conveyor, for example, but which preferably is not connected with the drive elements of the friction conveyor. The additional support elements provided by the invention so as to not transmit at least a part of the weight of the workpiece to the motion element, are advantageous in that the friction conditions occurring between the friction surface of the motion element and the drive elements of the friction conveyor are not negatively influenced.

Moreover, the separation of the workpiece carrier device into a motion element and a carrier element, as provided by the invention, allows to design them with different dimensions. Thus, it is possible to connect a relatively small motion element with a relatively large carrier element suitable for receiving workpieces of large dimensions. In particular, it is possible to provide a modular system wherein identical motion elements are connected with different carrier elements, in particular carrier elements of different outer dimensions.

The invention will be described hereinafter with reference to a friction conveyor, where appropriately designed workpiece carrier devices are always also suitable for use with a chain conveyor if their motion element is a toothed rack, for example.

The invention provides two motion elements arranged perpendicularly to each other. Thus, a workpiece carrier can be redirected at a right angle, with the motion element which is in a motion position being moved, especially lifted, into a stop position, and the motion element arranged perpendicularly to that motion element being moved, especially lowered, from a stop position into a motion position.

In a particular preferred embodiment a respective second motion element is preferably provided per motion element so that one, preferably two, pairs of motion elements are formed. The two motion elements of each motion element pair are preferably arranged in parallel with each other. Therefore, with respect to the transport direction of a workpiece carrier, the two motion elements may be arranged on the left and the right side of the especially frame-shaped carrier element below the frame elements, respectively. It is thus possible to transmit force to the workpiece carrier from two separate friction conveyors via the motion elements. Further, providing two motion elements is advantageous in that the structure of corresponding conveyor devices is simplified, since the friction conveyor may be arranged on the left or the right side.

The motion element pair preferably provided according to the invention comprises at least one, preferably two, opposite common contact elements. Therefore, the two motion elements of the pair of motion elements are always moved together in the vertical direction. Thus, canting or inadvertent twisting of the workpiece carrier is avoided.

In a particularly preferred embodiment, the workpiece carrier device comprises two pairs of motion elements. Each of the two motion element pairs has two motion elements preferably arranged in parallel. The motion elements of the two motion element pairs are preferably arranged under an angle of 90° with respect to each other. Thus branches in the conveyor device can be realized in a simple manner, the workpiece carrier being displaced sideways at the branch. It is not necessary, at a branch, to turn the workpiece carrier or to guide it along a bend. Rather, at a branch, the motion element pair in the motion position is lifted first so that the workpiece carrier stops at the branch. Thereafter, the second pair of motion elements arranged perpendicularly to the first pair of motion elements is lowered from a stop position to a motion position, contacts friction conveyors extending perpendicularly to the previous travelling direction and is thereby transported laterally toward the branch. By providing two mutually perpendicular pairs of motion elements, realizing a redirection of a workpiece carrier at a branch no longer requires lifting the entire workpiece carrier. Accordingly, corresponding lifting devices which are complex, especially when heavy workpieces are involved, are not required.

A combination is of course also conceivable so that a pair of motion elements and a single motion element are provided, the single element being arranged perpendicularly to the pair of motion elements.

In the above described preferred developments of the invention that allow for a simple redirecting, a retaining element is preferably provided. The retaining element, which in particular is a mechanical retaining element, guarantees that the motion element not needed at the moment or the pair of motion elements not needed at the moment is held in the stop position. For example, the retaining element could be a solenoid. In order to avoid providing batteries or supplying current to the workpiece carrier, the preferred embodiment of the retaining element is also mechanical. The retaining element may rotatable or pivotable and preferably comprises a projection which, in the stop position, engages into a recess in the connecting elements, one of the motion elements or a component connected therewith. Rotating, pivoting or displacing the retaining element may occur at the branch. This may be realized by establishing a form-fit and/or friction engagement between the retaining element and an actuator element. The actuator element, which is especially driven electromotively, causes a displacement and/or pivoting of the retaining element in order to fix the corresponding motion element or the corresponding pair of motion elements in the stop position.

The preferably several supporting elements preferably are supporting elements comprising supporting rollers. Via the supporting rollers, preferably provided on the bottom side of the carrier element, at least a part of the weight force exerted by the workpiece can be transferred to a corresponding absorption element. The absorption element may be a planar device forming a roller path which may be provided independently of the drive elements of the friction conveyor. The arrangement and the geometrical dimensions of the motion element and the carrier element of a workpiece carrier device may preferably be selected such that the entire weight force of the workpiece is absorbed by the supporting elements. Preferably, this is achieved with supporting elements having supporting rollers, a particularly preferred embodiment of the supporting rollers being pivotable about pivot axes. This guarantees hat no undesired friction occurs between the supporting elements and the corresponding contact surface.

To guarantee that the entire weight force or at least a substantial part of the weight force is absorbed by the supporting elements or that only a defined part of the weight force of the workpiece is transmitted to the motion element, an interrupting element may be provided between the carrier element and the motion element. The interrupting element may be, for example, a damping element of elastic material, a spring, or the like. For example, using a spring that would simultaneously serve as a pressing element, would guarantee a defined pressing force between the friction surface of the motion element and the drive elements of the friction conveyor. Also when the weight of the workpiece is increased, the provision of an interrupting element allows to prevent an increase in the friction forces occurring between the friction surface and the friction conveyor.

Preferably, the at least one motion element is longitudinal in shape and extends over more than half, in particular more than two thirds of the length of the workpiece carrier device. The width of the at least one motion element is preferably less than 5 cm, especially less than 3 cm, the length of the at least one motion element being at least 20, in particular at least 30 cm.

In a preferred development of the invention, the workpiece carrier device is designed such that the at least one motion element comprises a displacement means. Using the displacement means, it is possible to displace the motion element between a motion position and a stop position. Here, the motion element contacts the friction conveyor in the motion position. The displacement means allows to displace or lift the motion element so that it is spaced from the friction conveyor and no longer contacts the same. Should the conveyor be a chain conveyor, the displacement means is configured appropriately, the motion element being displaced such that the form-fit element, such as a toothed rack, connected with the motion element is disengaged from the chain.

It is thus possible to move the friction conveyor on, i.e. in particular the drive rollers or belts of a friction conveyor or the drive belts or plates of the friction conveyor, since no farces are transmitted to the motion element due to the spaced relationship. For example, if driven rollers are provided, these may keep rotating, Thus, no friction clutches need be provided. Even if, for example for reasons of safety, friction clutches are still provided, no fine adjustment and a regular readjustment in short intervals is no longer required. By providing the present workpiece carrier device, the costs of friction conveyors can thus be reduced substantially.

The displacement of the motion element may be effected, for example, electrically by providing an electric motor, possibly with an appropriate transmission. It is thus possible that an electric motor meshes with a toothed rack, the toothed rack being connected with the motion element such that it extends vertically, thereby allowing the motion element to be displaced vertically in a simple manner. To displace the motion element into the motion position or the stop position, an appropriate electric contact or switch may be provided. The same will be actuated, for example, upon bumping into another workpiece carrier, i.e. in a back-up situation, or when stopping at a working station.

In a particularly preferred embodiment, the displacement means is of mechanical design. Preferably, the displacement means comprises an actuator element. The actuator element, which is rod-shaped, for example, and in particular horizontally displaceable, cooperates with a transfer element. This transfer element, e.g. in the form of a pin, is connected with the motion element. The transfer element converts the motion of the actuator element, especially a horizontal displacement of the actuator element, in particular into a vertical displacement of the motion element.

In this context, it is particularly preferred for the displacement means, in particular the actuator element, to comprise a converter means for converting the movement of the actuator element into the displacement of the motion element. The converter element may be a comprise a cam or a slotted guide means, for example. For example, the actuator element can be displaced horizontally by the workpiece carrier device bumping against a stopper or another workpiece carrier means. Through the converter means and the transfer element, the horizontal displacement is then converted into a vertical displacement of the motion element. Thereby, the motion element is caused to assume the stop position, so that no conveying forces can be transmitted from the friction conveyor to the friction surface of the motion element.

Preferably, the actuator element, which in particular is of a rod-like shape, is formed with a contact element. For example in a back-up situation of the workpiece carrier means, the contact element actuates the actuator element. Likewise, the contact element may serve to actuate the actuator element at a working station. Like a bumper, the contact element, which in particular is fixedly connected with the actuator element, may be arranged at the front side of the workpiece carrier means, seen in the conveying direction.

Preferably, the converting means is designed as a part of the actuator element and exclusively serves to move the motion element into the stop position. For example, by providing a spring or due to the own weight of the motion element, the same is moved back into the motion position after being released by the displacement means. Thus, the motion element is preferably moved into the motion position using a pressing device that may take the form of a spring.

Preferably, the actuator element comprises two contact elements that are, in particular, arranged opposite each other. This is advantageous in that the workpiece carrier can be moved at least in two directions. The two contact elements are preferably connected with a common connecting element. In a particularly preferred development of this embodiment, the converter means, which converts the horizontal displacement of the actuator element into a vertical displacement of the motion element, is configured such that the motion element is displaced vertically regardless of the contact element that causes a horizontal displacement. To thereby allow a movement of the motion element from a motion position into the stop position as soon as one of the two contact elements is actuated, the converter means preferably comprises a guide track. In a particularly preferred embodiment, the guide track, formed, for example, as a slot in the connecting element and preferably engaged by a pin connected with the carrier element, comprises two track sections. The track sections form two parts of the guide tracks inclined with respect to the horizontal orientation. When the guide track is provided as a slot or recess in the guide element engaged by a pin connected with the carrier element, displacing the connecting element in the horizontal direction by actuating one of the two contact elements causes the pin to slide along one of both track sections. Since the track sections are inclined relative to the horizontal, the connecting element and thus the motion element are automatically shifted vertically.

Preferably, the carrier element has an assembly opening. Thus, the carrier element is not a continuous plate, but, for example, a frame-shaped element. Because of the assembly opening it is possible to perform working or assembly steps even on a bottom face of the workpiece directed downward towards the carrier element. The workpiece need not be lifted. Thus, complex lifting devices can be avoided, especially for heavy workpieces. Preferably, the frame elements of the especially rectangular and frame-like carrier element are less than 15 cm wide. Preferably, the width of all four frame elements is substantially identical.

To provide as free an accessibility of the workpiece as possible from below, the at least one motion element is arranged outside the assembly opening, i.e. horizontally beside the assembly opening. Preferably, the at least one motion element is additionally arranged below a frame element of the carrier element. With such a position of the at least one motion element, an assembly opening as large as possible is formed and it is avoided that a motion element arranged on the outside and laterally beside the carrier element hinders conventional assembly work on the corresponding side of the workpiece.

Instead of a workpiece carrier device for a friction conveyor, a correspondingly designed workpiece carrier device for a chain conveyor may be constructed such that an assembly opening is provided in the carrier element. Here, the at least one motion element is preferably arranged as described above. Instead of a friction surface, the motion element only comprises a form-fit element, such as a toothed rack, engaged by the chain of the chain conveyor.

Further, the invention refers to a conveyor device, in particular a chain or friction conveyor. The conveyor device has at least one drive element such as a belt, rollers or the likes for transmitting drive forces onto a friction surface of the workpiece carrier means. Similarly, the drive element may be a chain or the like by which drive forces can also be transmitted via a form-fit element to a motion element connected with a workpiece carrier. The conveyor device is preferably designed such that it cooperates with the above described workpiece carrier devices.

The conveyor device will be described hereinafter again with reference to a friction conveyor.

The friction conveyor of the invention comprises several drive elements for transmitting drive forces to a friction surface of a workpiece carrier device. With a roller conveyor, the drive elements are are at least partly driven rollers. Resting on the rollers is the friction surface of the motion element of the above described workpiece carrier device, for example, so that the workpiece carrier device is moved by friction forces. According to the invention, the friction conveyor comprises separate absorption elements in addition to the drive elements, the absorption elements absorbing at least a part of the weight force of the workpiece. By providing separate absorption elements, i.e. absorption elements that are in particular spatially separated from the drive elements, it is possible to transport workpieces of heavy weight, since the negative friction conditions between the friction surface of the workpiece carrier and the drive elements, caused by the heavy weight, are avoided. According to the invention, at least a part of the weight force is absorbed exclusively by the absorption elements, so that the flow of force of this part is not directed via the drive elements. Further, the additional provision of absorption elements allows for a flexible design thereof and to define the position of the absorption elements regardless of the position of the drive elements. A corresponding conveyor means can thus be adapted in a simple manner to different workpiece carrier means, e.g. workpiece carrier means of different widths. This would merely require a different arrangement of the absorption elements, while the arrangement of the drive elements could possibly be maintained.

### BRIEF DESCRIPTION OF THE DRAWINGS

The following is a detailed description of the individual inventions with reference to preferred embodiments and to the accompanying drawings.

In the Figures:

FIG. 1 is a schematic perspective diagram of a workpiece carrier device of the present invention on a conveyor device of the present invention,

FIG. 2 is a schematic section along line II-II in FIG. 1,

FIG. 3 is a schematic bottom view of the workpiece carrier device illustrated in FIG. 1,

FIG. 4 is a schematic perspective view of the bottom side of the workpiece carrier device in the direction of the arrow IV in FIG. 3, and

FIG. 5 is a schematic view of the elements of the displacement means, integrated at least in part in a carrier element of the workpiece carrier device, together with the motion elements.

### DETAILED DESCRIPTION OF PREFERRED EMBODIMENTS

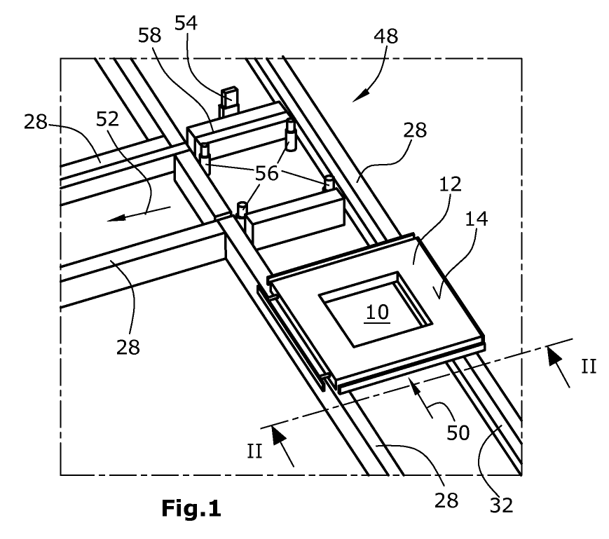

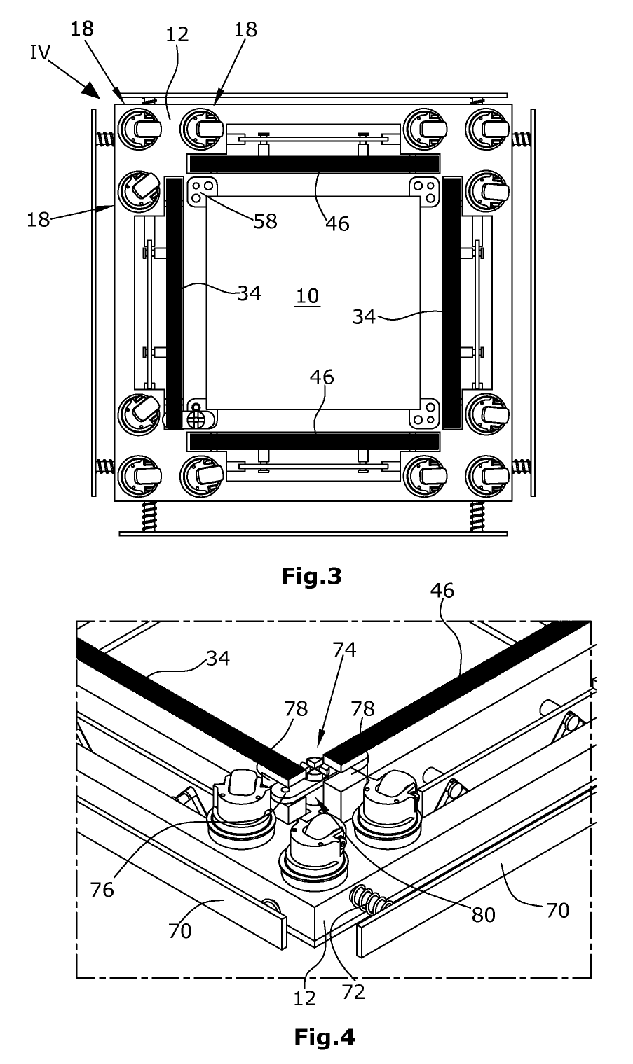

In the embodiment illustrated, a carrier element 12 of a workpiece carrier device is of frame-like configuration to receive a workpiece (not illustrated). An assembly opening 10 is formed therein, which is of square shape in the embodiment illustrated. A workpiece to be conveyed by the workpiece carrier is placed on the upper surface 14 of the carrier element and/or connected with the carrier element by fasteners, such as screws, clamping elements or the like. As is obvious in particular from FIG. 1, as well as from FIG. 3, the assembly opening 10 is freely accessible. A workpiece placed on the upper surface 14 of the carrier element 12 is thus accessible from below through the assembly opening 10. Thus, the workpiece can be easily assembled or worked on from below. In particular. No further parts of the workpiece carrier device are arranged such that they protrude into the assembly opening so that, at a corresponding assembly or work station, where the workpiece has to be accessible from below, the accessibility is not limited or hindered.

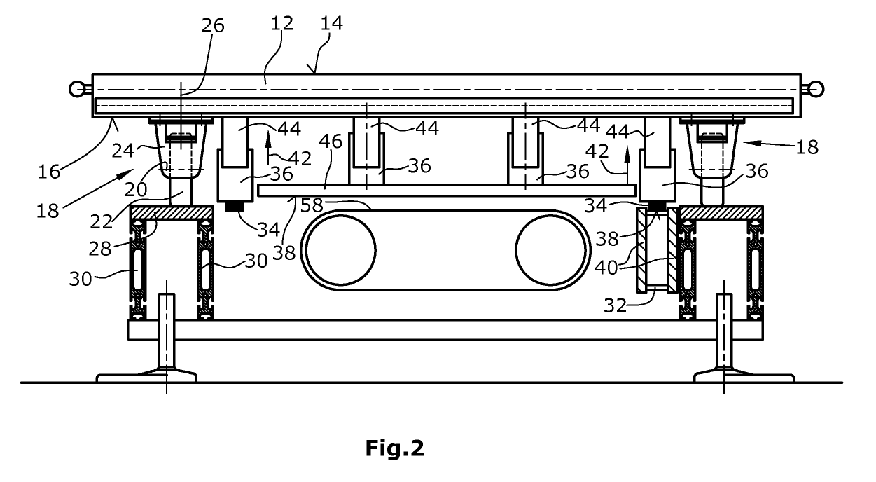

In the embodiment illustrated, the workpiece carrier is moved by means of a friction carrier. For this purpose, the bottom side 16 (FIG. 2) of the carrier element 12 is provided with supporting elements 18. Preferably, the supporting elements 18 are rollers 22 rotatable around an axis 20. A fastener 24 connects rollers 22 to the bottom side 16 of the carrier element 12 such that they are pivotable about an axis 26. The axis 26, which is preferably perpendicular to the carrier element 12, is offset with respect to the axis of rotation 20 of the rollers 22, so that the rollers 22 are designed as castor rollers. In this particularly preferred embodiment of the supporting elements as castor rollers, it is readily possible to cause an automatic pivoting of the supporting elements 18 when changing direction at a corner or at branches. Complex steering means are not required. Preferably, three supporting elements 18 are arranged at each corner of the carrier element 12 (FIG. 3), although, for reasons of clarity, FIG. 2 shows only one supporting element 18 per carrier side. All supporting elements 18 are arranged at the bottom side 16 of the carrier element 12 outside the assembly opening 10.

Further, another preferred embodiment allows to provide ball rollers as supporting elements, instead of the rollers 22. Such supporting elements are particularly advantageous with light loads. Providing the ball rollers is particularly advantageous since no complex steering means or castor effect are required.

The rollers 22 rest on a planar absorption element 28. Thus, the weight of the workpiece is transferred onto the plate-shaped absorption element 28 via a part of the supporting elements 18 and dissipated by appropriate base elements or webs 30.

For the purpose of moving the workpiece carrier device by means of a friction conveyor, the webs 30 are connected with a circumferentially extending friction band 32 through appropriate fasteners. The friction band 32 is an endless band. A motion element 34 contacts the friction band 32 so as to move the workpiece carrier device. The motion element is supported by holders 36. In a motion position (FIG. 2, right hand side), a friction surface 38 of the motion element 34 abuts on a surface of the friction band 32 so that force is transmitted by friction, thereby causing the workpiece carrier to move in the direction of the friction band 32. The width of the motion element 34 can be such that it corresponds to the distance between the two sidewalls 40 that carry the friction band 32. Since the sidewalls 40 protrude beyond the upper surface of the friction band 32, the sidewalls 40 may in this case serve as guides for the entire workpiece carrier via the motion element 34. Possibly, the walls 40 are bevelled at the inner edge directed towards the motion element in order guarantee a secure introduction of the motion element 34 between the two walls and thus a secure contact between the friction surface 38 of the motion element 34 and the top surface of the friction band 32.

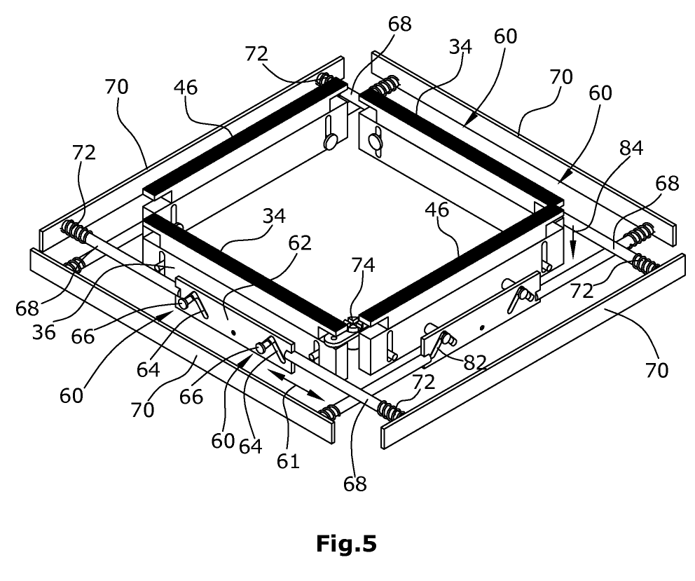

The motion element 34 may be shifted from a motion position (FIG. 2, right hand side) via a displacement means to be described hereunder with reference to FIGS. 4 and 5, in the direction of an arrow 42, i.e. towards the carrier element 12, to a stop position. In this position, the friction surface 38 of the motion element 34 is spaced from the upper surface of the friction band 32 so that the motion of the friction band 32 is no longer transmitted to the workpiece carrier device.

As can be seen in particular from FIG. 2, a motion element 34 with a respective holder 36 is provided not only on the right hand side, but a motion element 34 is also provided in parallel therewith on the left hand side, the motion element also being held by a holder 36. A holding element 44, fastened to the bottom side 16 of the carrier element 12, holds both holders 36 for displacement in the direction of the arrow 42. Due to the provision of a second motion element 34 arranged in parallel with the first motion element 34. It is irrelevant to the construction of the friction conveyor on which side the friction band 32 is arranged. It is also possible to provide friction bands 32 on both sides to increase the forces transmitted and to guarantee a simultaneous transmission of the forces. Further, providing two mutually parallel motion elements 34 is advantageous in that the workpiece carrier device can also be set on the conveyor device in a position turned about 180°.

Perpendicular to the two motion elements 34, two further motion elements 46 are provided that are identical to the motion elements 34. In FIG. 2, one of the two motion elements 46 is illustrated. Again, the same is connected with the carrier element 12 via holders 36, 44 and is shown in FIG. 2 as being in the stop position in which the motion element 46 is pulled upwards. Due to the second pair of motion elements 46 being perpendicular with respect to the first pair of motion elements 34, it is possible to redirect the workpiece carrier device in a simple manner at branches 48 (FIG. 1).

At a branch 48, schematically illustrated in FIG. 1, the workpiece carrier device, previously moved in the direction of an arrow 50, can be moved perpendicularly to this direction of transport in the direction of an arrow 52. In doing so, the workpiece carrier device is shifted sideways. The workpiece carrier device is not turned or redirected. When the transport direction is to be changed from the direction of movement 50 to the direction of movement 52, the workpiece carrier device is stopped using a stopping device 54. Thereby, the motion elements 34, as explained hereunder with reference to FIGS. 4 and 5, are moved from the motion position (FIG. 2) into a stop position, i.e. shifted upwards. Thereby, the motion element 34 on the right in FIG. 2 is spaced from the friction band 32 so that no force is transmitted from the friction band 32 to the motion element 34. In the next step, a holding element 74 is actuated by means of actuator elements 56 to be described hereunder with reference to FIGS. 4 and 5. Thereby, the other, second pair of motion elements 46 is shifted downward or released from the upward stop position and reaches the motion position. Thus, a friction surface 38 of the motion elements 46 comes into contact with the upper surface of a second friction conveyor 58 so that the workpiece carrier device is moved in the direction of the arrow 52.

The following is an explanation, with particular reference to FIGS. 3 to 5, of the displacement means 60 provided for the displacement of the motion elements 34, 46. The displacement means 60, as well as the elements cooperating with the displacement means 60, represent an invention independent of the provision of the assembly opening 10.

The displacement means 60 comprises an actuator means 62 that is displaceable in the longitudinal direction 61 and, in the embodiment illustrated, is of a plate-like shape. The actuator element 62 has slot-shaped guides 64 engaged by two pins 66. A slot 64 and an associated pin 66 respectively form a converter means for converting the displacement of the actuator element 62 in the direction of the arrow 61, i.e. in a horizontal direction, into a vertical displacement of the motion elements 34, 46, the vertical displacement of the motion elements 34, 46 being a displacement between the two positions, i.e. the stop position and the motion position. To achieve this, the pins 66 are fixedly connected with the holding element 36, the holding element 36 carrying the motion elements 34, 46. Further the actuator element 62 is connected with two connecting elements 68, which are rod-shaped in the embodiment illustrated, which are arranged within the carrier element 12 (FIG. 4). Two mutually parallel pairs of displacement means 60 thus comprise four connecting elements 68 oriented in the direction of displacement. Perpendicular to the displacement direction 61, two connecting elements 68 are respectively connected with a contact element 70. The contact elements 70 are provided outside the carrier element 12 and act as a kind of bumper.

Using positioning elements 72, which, in the embodiment illustrated, are helical springs 72 surrounding the connecting rods 68, the entire mechanic of the displacement means 60 is shifted such, when in an unloaded state, that the corresponding motion elements 34 or 46 are in the motion position, in which there is contact between the motion elements 34 or 46 and the corresponding friction line 32 or 58 (FIG. 1).

Using a holding element 74, it is possible to hold either the pair of motion elements 34 or the pair of motion elements 46 in the stop position, i.e. in the lifted position. For this purpose, the holding element 74 is pivotable about a longitudinal axis. In the stop position assumed by the pair of motion elements 34 in FIG. 4, a holding arm 76 of the holding element 74 engages into a recess 78 in the holding element 36. Due to the forces exerted by the springs 72, the holding element 36 is pressed against the holding arm 76 in the direction of an arrow 80. When the second pair of motion elements 46 is in the stop position, the holding element 74 can be pivoted to the right in FIG. 4 so as to engage into the recess 78 of the other pair of motion elements 46 and to hold the same in the stop position. Such a pivoting of the holding element 74 occurs when, for example, a movement direction 50 (FIG. 1) is to be changed to a movement direction 52. Pivoting the holding element 74 is effected in this instance by actuator elements 56 which may be driven electromotively.

In the embodiment illustrated, the pair of motion elements 46 (FIG. 5) is in the motion position, in which the motion elements 46 contact a friction band 32 (FIG. 1), for example. To shift the pair of motion elements 46 into the stop position, one of both contact elements 70 has to pushed inward. For example, this is effected when approaching the stopping device 54 (FIG. 1). Depending on which of the two contact elements 70 is shifted inward, the pin 66 slides along one of both track sections 82 of the slot or the guide track 64. Since the actuator element 62 can only be shifted in the direction of the arrow 61, the pair of motion elements 46 is shifted in the direction of the arrow 84 or a lifting and thus a transfer into the stop position is caused. In the embodiment illustrated, a vertical shifting of the actuator elements 62 is prevented by the connecting rods 68 being held in the carrier element 12 such that they are displaceable only in the longitudinal direction.

After the workpiece carrier device has been moved to the stopping device 54 and after the movement of the pair of motion elements 46 into the stop position caused thereby, both pairs of motion elements 34, 46 are in the stop position. Thereafter, the holding element 74 is pivoted so that the pair of motion elements 34 are released. Due to the springs 72, the actuator element 62 is shifted such that the pins 66 are located at the transition between the two track sections 82. Thereby, the pair of motion elements 34 is lowered to the motion position. This establishes a friction contact with the friction track 58 so that the workpiece carrier device is transported in the direction of the arrow 52 (FIG. 1).

As is visible in particular in FIGS. 3 and 4, it is particularly preferred to provide a plurality of supporting elements 18, especially three supporting elements 18, in each corner region of the carrier element 12. It is particularly preferred to respectively arrange two supporting elements 18 one behind the other, depending on the transport direction. In this context, the transport directions in FIG. 3 are from the left to the right and from the top down. Thus, in each transport direction, the arrangement of the supporting elements 18 is a tandem arrangement of supporting elements. Thereby, a smooth crossing of discontinuities in a friction conveyor track at branches or at corners becomes possible in a simple manner.

Although the invention has been described and illustrated with reference to specific embodiments thereof, it is not intended that the invention be limited to those illustrative embodiments. Those skilled in that art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A workpiece carrier device for loose placement on friction or chain conveyors, comprising
at least one motion element with a friction surface in contact with the friction conveyor or with a form-fit element cooperating with the chain conveyor for transmitting movement through friction forces or form-fit engagement, respectively,
a carrier element for receiving a workpiece, said carrier element being connected with the motion element, and
at least one supporting element for absorbing at least a part of the workpiece weight, said supporting element being connected with the carrier element and being independent of the motion element,
wherein
at least two motion elements are provided that are perpendicular to each other.

2. The workpiece carrier device of claim 1, wherein two pairs of motion elements are provided, each comprising two motion elements, the motion elements of one pair of motion elements preferably being parallel to each other.

3. The workpiece carrier device of claim 1, wherein the supporting element comprises supporting rollers arranged in particular at the bottom side of the carrier element.

4. The workpiece carrier device of claim 1, wherein the supporting elements are arranged such that the entire workpiece weight is absorbed by the supporting elements and/or the supporting elements are pivotable in particular about pivot axis extending in the supporting direction.

5. The workpiece carrier device of claim 1, wherein a displacement device is provided for displacing one of the motion elements into a stop position in which the friction surface or the form-fit element is arranged at a distance from the friction or chain conveyor.

6. The workpiece carrier device of claim 5, wherein the displacement device causes a vertical displacement of one of the motion elements between the motion position and the stop position.

7. The workpiece carrier device of claim 6, wherein the displacement device comprises an actuator element cooperating with a transfer element connected with said motion element.

8. The workpiece carrier device of claim 7, wherein the displacement means, in particular the actuator element, has a converter element for converting in particular a horizontal movement of the motion element into a vertical movement of the motion element, said converter element being provided in particular for the transfer of the motion element into the stop position.

9. The workpiece carrier device of claim 7, wherein the actuator element comprises a contact element arranged in front of the carrier element, in particular with respect to the transport direction of the workpiece carrier device.

10. The workpiece carrier device of claim 9, wherein the contact element is connected with a connecting element which is in particular rod-shaped and is preferably arranged substantially within the carrier element.

11. The workpiece carrier device of claim 9, wherein a motion element, in particular a pair of motion elements, comprises two mutually opposite contact elements.

12. The workpiece carrier device of claim 11, wherein the two contact elements are connected through common connecting elements.

13. The workpiece carrier device of claim 11, wherein the converter device comprises a guide track configured such that, starting from the motion position, the motion element is moved to the stop position when one of the two contact elements is actuated.

14. The workpiece carrier device of claim 13, wherein the guide track has two track sections inclined with respect to the horizontal plane and directed toward the respective contact element.

15. The workpiece carrier device of claim 11, wherein the pair of motion elements comprises at least one, in particular two common contact elements.

16. The workpiece carrier device of claim 5, wherein a holding element is provided which holds the motion element not in use, especially the pair of motion elements not in use, in a stop position.

17. The workpiece carrier device of claim 1, wherein the carrier element has an assembly opening so that a workpiece on the carrier element is accessible from below.

18. The workpiece carrier device of claim 17, wherein the carrier element is configured as a frame to form the assembly opening.

19. The workpiece carrier device of claim 17, wherein the motion elements are arranged outside the assembly opening.

20. The workpiece carrier device of claim 1, wherein the motion elements are arranged below the carrier element, in particular below a frame element of the carrier element.

21. A conveyor device, especially a friction conveyor, comprising
at least one drive element for transmitting drive forces to a friction surface or a form-fit element of a workpiece carrier device, in particular a workpiece carrier device of claim 1, and
at least one separate absorption element, independent of the drive elements, for absorbing at least a part of the weight force of the workpiece carrier device of the workpiece arranged on the workpiece carrier device.
